(19) United States
(12) Patent Application Publication
(10) Pub. No.: US 2010/0197158 A1
(43) Pub. Date: Aug. 5, 2010

(54) CABLE CONNECTOR

(75) Inventors: Hirohisa TANAKA, Tsu (JP); Shunsuke HASHIMOTO, Tsu (JP)

Correspondence Address: GREENBLUM & BERNSTEIN, P.L.C., 1950 ROLAND CLARKE PLACE, RESTON, VA, 20191, US

(73) Assignee: PANASONIC ELECTRIC WORKS CO., LTD., Osaka (JP)

(21) Appl. No.: 12/693,963

(22) Filed: Jan. 26, 2010

Related U.S. Application Data
(63) Continuation of application No. 12/052,062, filed on Mar. 20, 2008, now Pat. No. 7,695,299.

(30) Foreign Application Priority Data
Mar. 27, 2007 (JP) 2007-081569

(51) Int. Cl. H01R 13/62

(52) U.S. Cl. 439/341

(57) ABSTRACT

A cable connector includes a housing and a first contact provided in the housing. The first contact includes a first engaging and pivoting unit opposed to a back surface of the cable. The cable connector also includes a second contact which is provided in the housing and which includes a second engaging and pivoting unit opposed to the back surface of the cable. The second engaging and pivoting unit has a root which is thicker than that of the first engaging and pivoting unit. The cable connector also includes a cover. The cover includes a first through hole into which the first engaging and pivoting unit is inserted, a first cam unit engaged with the first engaging and pivoting unit, a second through hole into which the second engaging and pivoting unit is inserted, and a second cam unit engaged with the second engaging and pivoting unit.

### CROSS-REFERENCE TO RELATED APPLICATION

This application is a Continuation of pending U.S. patent application Ser. No. 12/052,062, filed on Mar. 20, 2008, which claims the priority of Japanese Patent Application No. 2007-081569, filed Mar. 27, 2007, the disclosures of which is expressly incorporated by reference herein in its entirety.

### BACKGROUND OF THE INVENTION

The present invention relates to a cable connector, and more particularly, to a cable connector suitable for connecting a cable such as a flat ribbon cable and FPC.

As a conventional cable connector, Japanese Patent Application Laid-open No. 2001-110483 (hereinafter, Patent Document 1) discloses a cable connector including a housing that receives an FPC cable, a plurality of first and second contacts fixed and held by the housing with a predetermined pitch, and an actuator that brings the FPC cable into contact with the first and second contacts under pressure.

According to the Patent Document 1, the first and second contacts are respectively integrally provided with first and second contact units which are opposed to one of surfaces of the FPC cable, and first and second engaging and pivoting units which are opposed to the opposite surface of the FPC cable. An outer periphery of the first engaging and pivoting unit is formed into an arc shape, and the arc first cam unit formed on the actuator and the arc first engaging and pivoting unit are engaged with each other. The actuator is formed with a through hole which is adjacent to the first cam unit such that the first engaging and pivoting unit runs around the first cam unit. With this configuration, the actuator is supported by the first engaging and pivoting unit such that the actuator can turn. The actuator is provided with an engaging cam groove, and the engaging cam groove and the second engaging and pivoting unit are engaged with each other.

### SUMMARY OF THE INVENTION

According to the conventional technique, however, since the second engaging and pivoting unit of the second contact is in engagement with the engaging cam groove of the actuator, the opening operation of the actuator is restricted by the engagement between the engaging cam groove and the second engaging and pivoting unit at the time of opening operation of the actuator, and the opening angle of the actuator can not sufficiently be secured. Thus, the moving amount of the actuator is reduced when the cable is fixed, and there is a problem that the operability is deteriorated.

Therefore, an object of the present invention is to provide a cable connector in which the operability when a cable is fixed is enhanced.

To achieve the above object, the present invention provides a cable connector comprising a housing, a first contact which is provided in the housing and into which a sheet-like cable is inserted, and which includes a first contact unit opposed to a front surface of the cable and a first engaging and pivoting unit opposed to a back surface of the cable, a second contact which is provided in the housing in a side-by-side relation with the first contact, into which a cable is inserted, and which has a second contact unit opposed to the front surface of the cable and a second engaging and pivoting unit which is opposed to the back surface of the cable and which has a root thicker than that of the first engaging and pivoting unit, and a cover which includes a first through hole into which the first engaging and pivoting unit is inserted, a first cam unit engaged with the first engaging and pivoting unit, a second through hole into which the second engaging and pivoting unit is inserted and a second cam unit engaged with the second engaging and pivoting unit, which is turnably supported on the first engaging and pivoting unit by the first through hole and the first cam unit, which is turnably supported on the second engaging and pivoting unit by the second through hole and the second cam unit, and which brings the cable into contact with the contact units under pressure.

It is preferable to be configured that the first engaging and pivoting unit is engaged with the first cam unit so that the cover can move in an inserting and releasing direction of the cable, and the second engaging and pivoting unit limits movement of the cover in an inserting direction of the cable.

Further, it is preferable to be configured that the first contact is inserted into the housing along a separating direction of the cable, and the second contact is inserted into the housing along an inserting direction of the cable.

Further, it is preferable to be configured that a substantially arc projection which locks the cover in a state where the cover is opened is provided on a tip end of the second engaging and pivoting unit.

### BRIEF DESCRIPTION OF THE DRAWINGS

FIG. 1 is a perspective view of an external appearance of a cable connector according to an embodiment of the present invention;

FIG. 2 is a plan view of a housing of the cable connector of the embodiment;

FIG. 3 is a front view of a cover of the cable connector of the embodiment;

FIG. 4 is a sectional view of a first contact of the cable connector of the embodiment and shows a state where a cover is opened;

FIG. 5 is a sectional view of the first contact of the cable connector of the embodiment and shows a state where the cover is closed;

FIG. 6 is a sectional view of a second contact of the cable connector of the embodiment and shows a state where a cover is opened; and

FIG. 7 is a sectional view of the second contact of the cable connector of the embodiment and shows a state where the cover is closed.

### DETAILED DESCRIPTION OF THE PREFERRED EMBODIMENTS

Embodiments of the present invention will be explained below in detail with reference to the drawings.

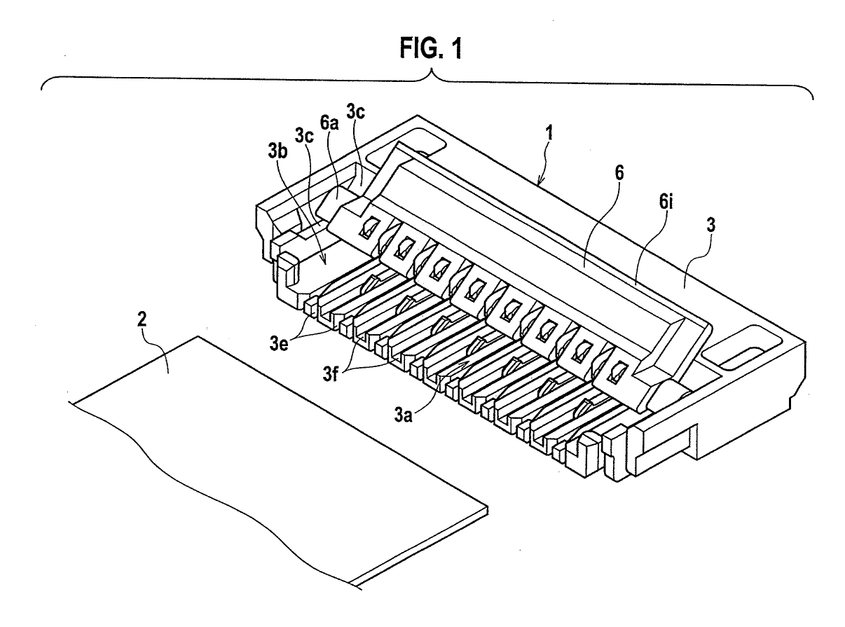

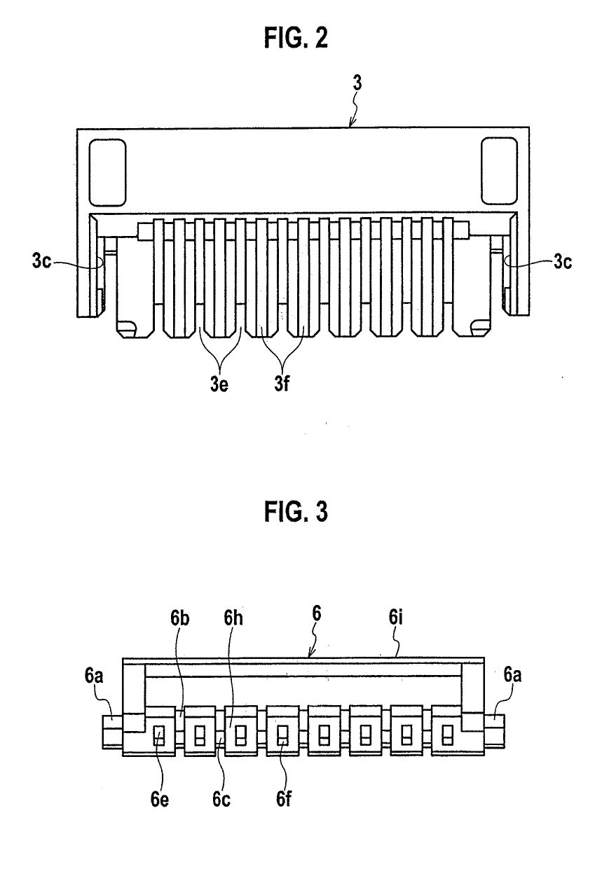

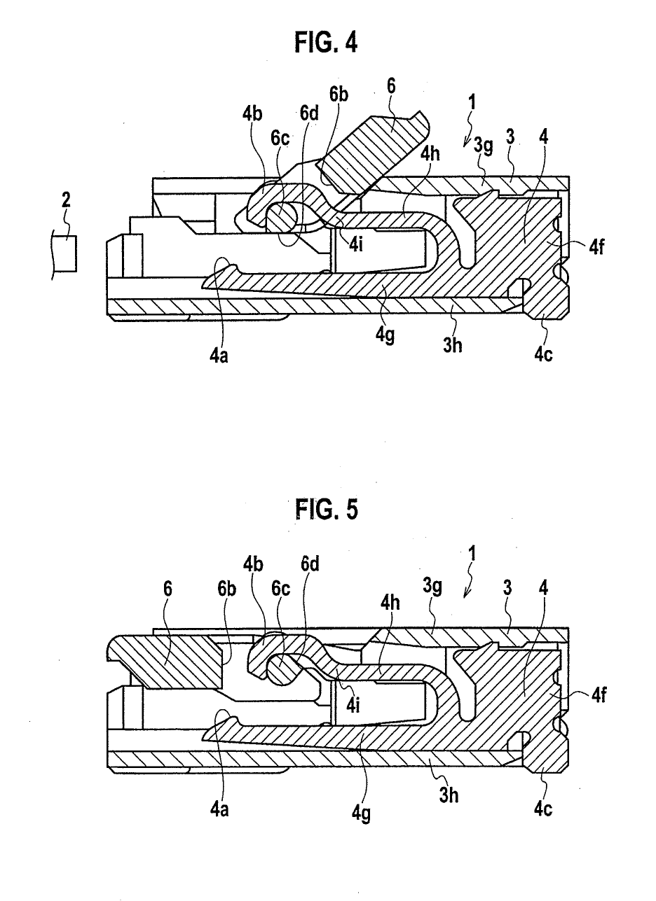

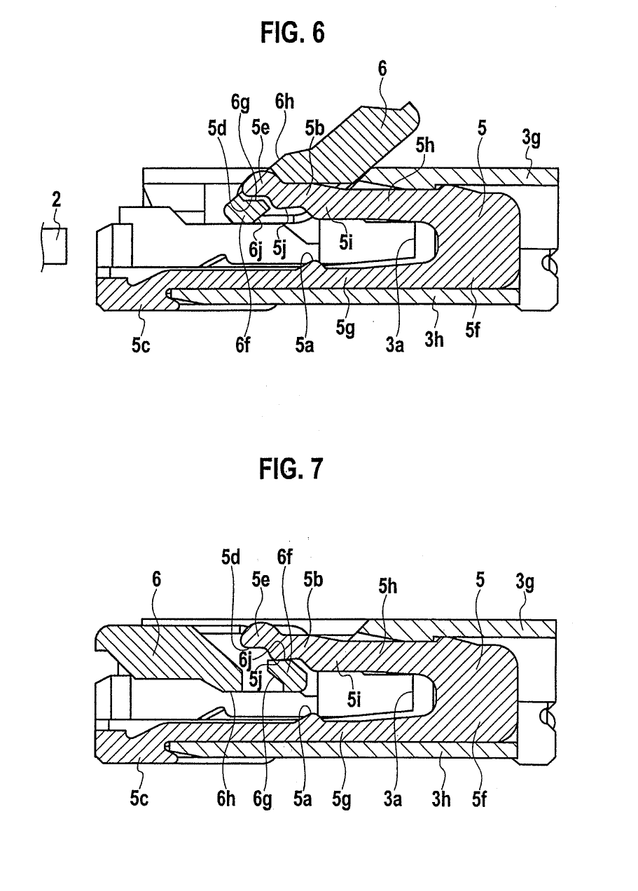

FIG. 1 is a perspective view of an external appearance of a cable connector according to an embodiment of the present invention, FIG. 2 is a plan view of a housing, FIG. 3 is a front view of a cover, FIG. 4 is a sectional view of a first contact and shows a state where a cover is opened, FIG. 5 is a sectional view of the first contact and shows a state where the cover is closed, FIG. 6 is a sectional view of a second contact and shows a state where the cover is opened, and FIG. 7 is a sectional view of the second contact and shows a state where the cover is closed.

A cable connector 1 includes an insulative housing 3 into which a sheet cable 2 such as FPC or FFC, having front surface and back surface. The cable connector 1 includes a plurality of insulative first contacts 4 which are arranged in one row at a predetermined pitch in the housing 3 and fixed and held therein. The first contact 4 includes a first contact unit 4a opposed to the front surface of the cable 2 and a first engaging and pivoting unit 4b opposed to the back surface of the cable 2. The cable connector 1 also includes a plurality of insulative second contacts 5 held in the housing 3 in parallel to the first contacts 4. The second contacts 5 include a second contact unit 5a opposed to the front surface of the cable 2 and a second engaging and pivoting unit 5b opposed to the back surface of the cable 2. The cable connector 1 also includes an insulative cover 6 which can turn between an open position where the cable 2 can be inserted into the housing 3 and a close position where the cable 2 inserted into the housing 3 can be pushed toward the first and second contact units 4a and 5a.

The housing 3 is made of insulative material such as synthetic resin. The housing 3 is formed at its vertically substantially intermediate portion with a bag-like cable receiving unit 3a into which the cable 2 is inserted from front (left side in FIG. 4).

A large number of conductors (not shown) are longitudinally exposed in two rows in a staggered form from a surface (lower surface in FIG. 4) of an insertion end of the cable 2.

A substantially half of an inlet side (front side) of an upper wall 3g of the housing 3 is removed, and an upper opening 3b for accommodating the cover 6 is formed at that portion.

Bearings 3c are formed at both ends of the upper opening 3b of the housing 3. Upper sides of the bearings 3c are opened. The bearings 3c are opposed to each other in the longitudinal direction of the housing 3.

The cover 6 is a plate-like member which can be accommodated in the upper opening 3b of the housing 3. The cover 6 is also made of insulative material such as synthetic resin. Pivot shafts 6a projects from base ends of left and right end surfaces of the cover 6. In the present embodiment, the left and right pivot shafts 6a of the cover 6 are placed on the left and right bearings 3c of the housing 3 from above the housing 3. With this configuration, the cover 6 is mounted on the upper opening 3b of the housing 3 such that the cover 6 can open and close (turn).

The cover 6 turns from an open position shown in FIGS. 4 and 6 to a close position shown in FIGS. 5 and 7. When the cover 6 is in the close position, the cover 6 assumes substantially horizontal attitude and is accommodated in the upper opening 3b, and the cover 6 pushes the cable 2 toward the contact units 4a and 5a (downward in FIG. 4). On the other hand, when the cover 6 is in the open position, the cover 6 rises from the upper opening 3b of the housing 3 in a backward inclined standing attitude, and a substantially half of the inlet side of the cable receiving unit 3a is opened above the housing 3 so that the cable 2 can be inserted into the cable receiving unit 3a of the housing 3. The cover 6 is provided with a knob 6i for opening the cover 6. In the present embodiment, the upper wall 3g of the housing 3 functions as a stopper which limits the turning motion of the cover 6 in the opening direction.

The first contacts 4 and the second contacts 5 are alternately arranged along the longitudinal direction of the housing 3. The first contacts 4 and the second contacts 5 are formed by punching a thin metal plate.

The first contacts 4 and the second contacts 5 are inserted into the housing 3 from two opposite directions. More specifically, the housing 3 is formed with a large number of first holes 3f into which the first contacts 4 are inserted one by one from back (deep side) to front (inlet side) of the housing 3, i.e., in the separating direction of the cable 2 (from right to left in FIG. 4), and with a large number of second holes 3e into which the second contacts 5 are inserted from front (inlet side) to back (deep side) of the housing 3, i.e., in the inserting direction of the cable 2 (from left to right in FIG. 6) one by one. The first contacts 4 and the second contacts 5 are alternately arranged in the housing 3 side-by-side in the longitudinal direction with the predetermined pitch through the first holes 3f and the second holes 3e. That is, the insertion amounts of the first contacts 4 and the second contacts 5 into the housing 3 can be adjusted.

The first contact 4 includes a base portion 4f which is fitted between upper and lower walls 3g and 3h at a deeper side than the cable receiving unit 3a of the housing 3, a lower arm unit 4g which extends from a lower end of the base portion 4f along the lower wall 3h of the housing 3 and which is arranged below the cable receiving unit 3a, and an upper arm unit 4h which extends to the upper opening 3b along the upper wall 3g of the housing 3 from the upper end of the base portion 4f and which is arranged above the cable receiving unit 3a.

The base portion 4f is provided at its upper edge with a projection. If the projection bites into the upper wall 3g of the housing 3 in the first hole 3f, the first contact 4 can be locked to the housing 3. A stopper 4c downwardly projects from a lower edge of the base 4f. The stopper 4c limits the maximum insertion amount of the first contact 4 into the housing 3 when the first contact 4 is inserted into the first hole 3f of the housing 3. The stopper 4c also serves as a surface mounting soldering unit projecting from a lower surface of the cable connector 1. As shown in FIG. 4, the stopper 4c downwardly projects from a tip end of the lower arm unit 4g.

The lower arm unit 4g is formed at its tip end with a first contact unit 4a. The lower arm unit 4g can elastically deform, and if the cable 2 is inserted, the lower arm unit 4g downwardly elastically deform so that an upper biasing force is applied.

A substantially hook-like first engaging and pivoting unit 4b is formed on a tip end of the upper arm unit 4h such that it can elastically deform in the vertical direction, and the engaging and pivoting unit 4b projects toward the upper opening 3b. In the present embodiment, the first engaging and pivoting unit 4b projects in the inserting direction of the cable 2 (right side in FIG. 4) than the position of the first contact unit 4a.

The second contact 5 includes a base portion 5f which is fitted in between the upper and lower walls 3g and 3h at a deeper side than the cable receiving unit 3a of the housing 3, a lower arm unit 5g which extends from a lower end of the base portion 5f to an inlet side front surface along the lower wall 3h of the housing 3 and which is arranged below the cable receiving unit 3a, and an upper arm unit 5h which extends from the upper end of the base portion 5f to the upper opening 3b along the upper wall 3g of the housing 3 and which is arranged above the cable receiving unit 3a.

The base portion 5f is provided at its upper edge with a projection. If the projection bites into the upper wall 3g of the housing 3 in the second hole 3e, the second contact 5 is locked to the housing 3.

The lower arm unit 5g is formed at its substantially intermediate portion with the second contact unit 5a, and the stopper 5c downwardly projects from a lower edge of a tip end of the lower arm unit 5g. The stopper 5c limits the maximum insertion amount of the second contact 5 into the housing 3 when the second contact 5 is inserted into the second hole 3e of the housing 3. The stopper 5c also serves as a surface mounting soldering unit projecting from a lower surface of the cable connector 1. As shown in FIG. 6, the stopper 5c downwardly projects from the tip end of the lower arm unit 5g.

The second engaging and pivoting unit 5b projects from a tip end of the upper arm unit 5h toward the upper opening 3b. The second engaging and pivoting unit 5b has a root 5i which is thicker than a root 4i of the first engaging and pivoting unit 4b. Since the root 5i is thick, the second engaging and pivoting unit 5b is less prone to be elastically deformed in the vertical direction as compared with the first engaging and pivoting unit 4b. In the present embodiment, as shown in FIGS. 6 and 7, a substantially arc projection 5e is provided on a tip end of the second engaging and pivoting unit 5b of the second contact 5, and the projection 5e locks the cover 6 in a state where the cover 6 is opened. A step-like engaging surface 5d is formed on a lower portion of the tip end of the second engaging and pivoting unit 5b, i.e., a lower portion of the projection 5e. A step-like abutting surface 5j is formed on a right side of the engaging surface 5d (in the inserting direction of the cable 2).

In the present embodiment, the first engaging and pivoting unit 4b and the second engaging and pivoting unit 5b project closer to the separating direction of the cable 2 (left side in FIGS. 4 and 6) than the position of the second contact unit 5a.

In a state where the first contacts 4 and the second contacts 5 are attached into the housing 3, the first contact units 4a of the first contacts 4 and the second contact units 5a of the second contacts 5 are arranged in the housing 3 in one row. As a result, the entire first and second contact units 4a and 5a are arranged in the staggered manner by the first contact units 4a of the first contacts 4 arranged in one row in the separating direction of the cable 2 and the second contact units 5a of the second contacts 5 arranged in one row in the inserting direction of the cable 2, and they can come into contact with the large number of conductors which are exposed in the staggered manner provided on the surface of the cable 2.

In the present embodiment, the first engaging and pivoting unit 4b and the second engaging and pivoting unit 5b are arranged in the housing 3 at a position above a location between the row of the first contact units 4a of the first contacts 4 and the row of the second contact units 5a of the second contacts 5.

The cover 6 is provided with a first through hole 6b in correspondence with the first engaging and pivoting unit 4b provided on the first contact 4. A first cam unit 6c which turns when the cover 6 turns is formed on the cover 6 at a location adjacent to the first through hole 6b. If the first engaging and pivoting unit 4b of the first contact 4 is engaged with the first cam unit 6c, the cover 6 is turnably supported by the first engaging and pivoting unit 4b. In the present embodiment, as shown in FIG. 4, the first engaging and pivoting unit 4b of the first contact 4 is engaged with the first cam unit 6c with play therebetween so that the first cam unit 6c can move in the inserting and releasing direction (inserting direction and releasing direction of the cable 2). Since the first engaging and pivoting unit 4b of the first contact 4 is engaged with the first cam unit 6c with play therebetween so that the first cam unit 6c can move in the inserting and releasing direction of the cable 2 in this manner, a friction force generated between the first engaging and pivoting unit 4b and the first cam unit 6c is reduced.

An outer surface of the cover 6 which is directed opposite side from the cable 2 when the cover 6 is in the close position is formed with an inclined surface 6d so that an end of the cover does not hinder the inserting motion of the cable 2 when the cover is opened. An inclined surface is also provided on the first cam unit 6c at a location corresponding to the inclined surface 6d, and the inclined surface 6d of the cover 6 and the inclined surface of the first cam unit 6c are flush with each other.

Cable pressing units 6h are formed on an inner surface of the cover 6 which is opposed to the cable 2 when the cover 6 is in the close position. The cable pressing unit 6h downwardly pushes the cable 2. The cable pressing unit 6h projects between the first through holes 6b in the inner surface of the cover 6.

Further, the cover 6 is provided with a second through hole 6e in correspondence with the second engaging and pivoting unit 5b provided on the second contact 5. As shown in FIG. 3, the second through hole 6e is formed such as to hollow out the cable pressing unit 6h. A second cam unit 6f which turns when the cover 6 turns is formed on the cover 6 at a location adjacent to the second through hole 6e. If the second engaging and pivoting unit 5b of the second contact 5 is engaged with the second cam unit 6f, the cover 6 is turnably supported by the second engaging and pivoting unit 5b.

In the present embodiment, an engaging cam surface 6g which is engaged with the engaging surface 5d when the cover 6 is opened is formed on the second cam unit 6f, and an abutting surface 6j which abuts against the abutting surface 5j when the cover 6 is closed is formed on the second cam unit 6f. As the cover 6 is opened or closed, the second cam unit 6f is turned from a position where the engaging cam surface 6g is engaged with the engaging surface 5d to a position where the abutting surface 6j abuts against the abutting surface 5j. The step-like abutting surface 5j provided on the second engaging and pivoting unit 5b limits the movement of the cover 6 in the inserting direction of the cable 2 and upward movement thereof.

According to the embodiment having the structure described above, if the cover 6 is opened, the cable 2 can easily be inserted into the cable receiving unit 3a.

If the cover 6 is turned to the closing position shown in FIGS. 5 and 7 after the cable 2 is inserted, the cable pressing unit 6h on the lower surface of the cover 6 presses the cable 2 toward the first contact unit 4a and the second contact unit 5a, the first contact unit 4a, the second contact unit 5a and the contact of the cable 2 are engaged with each other under appropriate pressure and they are electrically connected to each other. That is, the cable 2 is sandwiched between the first contact unit 4a and the second contact unit 5a, the lower arm unit 4g is elastically deformed downward by an amount corresponding to the thickness of the cable 2, and an appropriate contact pressure is obtained by the elastic force.

According to the present embodiment, the cover 6 is formed with the first through hole 6b and the first cam unit 6c, the first engaging and pivoting unit 4b is inserted into the first through hole 6b and is engaged with the first cam unit 6c, the cover 6 is formed with the second through hole 6e and the second cam unit 6f, the second engaging and pivoting unit 5b is inserted into the second through hole 6e and the second engaging and pivoting unit 5b is engaged with the second cam unit 6f. Therefore, the first engaging and pivoting unit 4b and the second engaging and pivoting unit 5b do not restrict the opening of the cover 6 at the time of opening operation of the cover 6, and the opening angle can be increased. As a result, the operability of the cover 6 when the cable 2 is fixed can be enhanced.

According to the present embodiment, the first engaging and pivoting unit 4b of the first contact 4 is engaged through the play so that the first cam unit 6c of the cover 6 can be moved in the inserting and releasing direction of the cable 2. Therefore, the first engaging and pivoting unit 4b does not limit the movement of the first cam unit 6c in the inserting and releasing direction (inserting direction and separating direction) of the cable 2, and it is possible to prevent a large friction force from being generated between the first engaging and pivoting unit 4b and the first cam unit 6c when the cover 6 is opened or closed, and the cover 6 can be opened and closed excellently.

According to the present embodiment, the second engaging and pivoting unit 5b of the second contact 5 limits the movement of the cover 6 in the inserting direction of the cable 2. Therefore, even if the first cam unit 6c of the cover 6 is engaged through the play so that the first cam unit 6c of the cover 6 can move in the inserting and releasing direction of the cable 2, since the movement of the cover 6 in the inserting and releasing direction of the cable 2 is suppressed, it is possible to suppress the saccadic movement when the cover 6 is opened or closed.

In the present embodiment, the turning center formed by engagement between the first cam unit 6c of the cover 6 and the first engaging and pivoting unit 4b of the first contact 4 is located above a position between the row of the first contact units 4a of the first contacts 4 and the row of the second contact units 5a of the second contacts 5. Therefore, the cover 6 can turn at a position where the cable 2 between the first contact unit 4a of the first contact 4 and the second contact unit 5a of the second contact 5 is prone to deform, and the cover 6 can be opened and closed more excellently.

Further, if the inserting amount of the first contact 4 and the second contact 5 into the housing 3 is appropriately set, there is a merit that the turning center of the cover 6 and the relative position between the first contact unit 4a and the second contact unit 5a are changed and a cable connector 1 having better operability can be obtained.

According to the present embodiment, the second engaging and pivoting unit 5b of the second contact 5 is provided with the step-like abutting surface 5j, and the cover 6 is provided with the abutting surface 6j which abuts against the abutting surface 5j when the cover 6 is closed. With this configuration, if the cover 6 is closed when the cable 2 is fixed, these abutting surfaces 5j and 6j limit the movement of the cover 6 in the inserting direction of the cable 2 and upward movement thereof. As a result, it is possible to prevent the closed cover 6 from opening when the cable is fixed, and the reliability of connection of the cable connector 1 can be enhanced. In the present embodiment, the second contact in which the thickness of the root 5i of the second engaging and pivoting unit 5b is thicker than the root 4i of the first engaging and pivoting unit 4b is used. With this configuration, the second engaging and pivoting unit 5b is less prone to elastically deform in the vertical direction, and it is possible to prevent the closed cover 6 from opening when the cable is fixed. As a result, the reliability of connection of the cable connector 1 can further be enhanced.

According to the present embodiment, the first contact 4 is inserted into the housing 3 along the separating direction of the cable 2, and the second contact 5 is inserted into the housing 3 along the inserting direction of the cable 2. With this configuration, the first contact 4 limits the movement of the cover 6 in the separating direction of the cable 2, and the second contact 5 can limits the movement of the cover 6 in the inserting direction of the cable 2. That is, since the first and second contacts 4 and 5 limit the movements of the cover 6 in the opposite directions, it is possible to prevent the cover 6 from rattling, and the cover 6 is not easily pulled out. In the present embodiment, the first contact 4 is inserted along the same direction as a direction in which the first engaging and pivoting unit 4b limits the movement of the cover 6 (separating direction of the cable 2), and the second contact 5 is inserted along the same direction as a direction in which the second engaging and pivoting unit 5b limits the movement of the cover 6 (inserting direction of the cable 2). Therefore, it is possible to make it more difficult to pull out the cover 6.

According to the present embodiment, the substantially arc projection 5e which locks the cover 6 in a state where the cover 6 is opened is provided on the tip end of the second engaging and pivoting unit 5b. Therefore, even if a force in the separating direction of the cable 2 is applied to the cover 6 when the cover 6 is opened, the substantially arc projection 5e locks the cover 6, it is possible to prevent the cover 6 from moving in the separating direction of the cable 2, and it is possible to make it difficult to break off the cover 6. Since the projection 5e is formed into the substantially arc shape, there is an advantage that the cover 6 can smoothly be operated along the projection 5e when the cover 6 is turned.

While the cable connector according to the exemplary embodiment of the present invention has been explained above, the present invention is not limited thereto and can also adopt various other embodiments without departing from the scope of the invention.

What is claimed is:

1. A cable connector, comprising
a housing,
a first contact which is provided in the housing and into which a sheet-like cable is inserted, and which includes a first contact unit opposed to a front surface of the cable and a first engaging and pivoting unit opposed to a back surface of the cable,
a second contact which is provided in the housing in a side-by-side relation with the first contact, into which a cable is inserted, and which has a second contact unit opposed to the front surface of the cable and a second engaging and pivoting unit which is opposed to the back surface of the cable and which has a root thicker than that of the first engaging and pivoting unit, and
a cover which includes a first through hole into which the first engaging and pivoting unit is inserted, a first cam unit engaged with the first engaging and pivoting unit, a second through hole into which the second engaging and pivoting unit is inserted and a second cam unit engaged with the second engaging and pivoting unit, which is turnably supported on the first engaging and pivoting unit by the first through hole and the first cam unit, which is turnably supported on the second engaging and pivoting unit by the second through hole and the second cam unit, and which brings the cable into contact with the first and second contact units under pressure, wherein
the first engaging and pivoting unit is engaged with the first cam unit so that the cover can move in an inserting and releasing direction of the cable, and the second engaging and pivoting unit limits movement of the cover in an inserting direction of the cable, wherein
a surface of the second engaging and pivoting unit, which abuts the second cam unit, comprises a step, and wherein
the step abuts the second engaging and pivoting unit when the cover is closed and disengages the second engaging and pivoting unit when the cover is opened.

2. The cable connector according to claim 1, wherein the first contact is inserted into the housing along a separating direction of the cable, and the second contact is inserted into the housing along an inserting direction of the cable.

3. The cable connector according to claim 1, wherein a substantially arc projection which locks the cover in a state where the cover is opened is provided on a tip

4. The cable connector according to claim 2 wherein a substantially arc projection which locks the cover in a state where the cover is opened is provided on a tip end of the second engaging and pivoting unit.
